(19) United States
(12) Patent Application Publication
(10) Pub. No.: US 2026/0168718 A1
(43) Pub. Date: Jun. 18, 2026

(54) Freezer Malfunction Notification Device

(71) Applicant: Thomas Kelley, Milton, FL (US)

(72) Inventor: Thomas Kelley, Milton, FL (US)

(21) Appl. No.: 19/295,879

(22) Filed: Aug. 11, 2025

Related U.S. Application Data
(60) Provisional application No. 63/733,007, filed on Dec. 12, 2024.

(51) Int. Cl. F25D 21/02

(52) U.S. Cl. CPC F25D 21/02; F25D 2300/00

(57) ABSTRACT

A freezer malfunction notification device is provided. The device is comprised of a body configured to retain a volume of freezable liquid, a lid including an opening and a gasket, an indicator disk, and an optional fastener for mounting to an interior surface of a refrigeration compartment. The body may be constructed from transparent or translucent materials. Upon freezing of the liquid within the body and subsequent placement of the indicator disk on the frozen liquid surface, any subsequent melting of the liquid due to temperature rise causes the disk to descend irreversibly downward within the body. This displacement is retained upon refreezing of the liquid, thereby visually indicating that a defrosting event has occurred.

### CROSS REFERENCE TO RELATED APPLICATION

The present application claims priority to, and the benefit of, U.S. Provisional Application No. 63/733,007, which was filed on Dec. 12, 2024, and is incorporated herein by reference in its entirety.

### FIELD OF THE INVENTION

The present invention relates generally to the field of freezers and refrigeration. More specifically, the present invention relates to a device that provides a persistent visual indication of a defrosting event within a freezer by using a freezable liquid and an indicator disk that descends irreversibly when the liquid melts due to a temperature rise. Accordingly, the present disclosure makes specific reference thereto. Nonetheless, it is to be appreciated that aspects of the present invention are also equally applicable to other like applications, devices, and methods of manufacture.

### BACKGROUND

Failures in refrigeration appliances such as freezers and refrigerators can lead to unnoticed temperature fluctuations that compromise the safety and quality of stored food. These malfunctions may occur due to power outages, mechanical defects, or improper sealing of the appliance doors. In residential settings, users often remain unaware that a temperature excursion has taken place until the food has already thawed, spoiled, or been refrozen, thereby increasing the risk of foodborne illness. In commercial environments such as restaurants, the impact is amplified due to the volume and value of perishable inventory involved. Cooking and serving previously thawed and spoiled items can lead to health code violations, customer illness, financial losses, and reputational damage. Conventional solutions for temperature monitoring, such as electronic thermometers or data loggers, may fail to provide persistent, low-cost, and easily interpretable visual confirmation of a past malfunction. Furthermore, reliance on electronic systems introduces the risk of sensor or power failure, which defeats the monitoring objective during a defrosting event.

Therefore, there exists a long-felt need in the art for a freezer malfunction notification device that provides a persistent and irreversible visual indicator of defrosting events. There also exists a long-felt need in the art for a freezer malfunction notification device that operates without electricity or sensors and functions reliably during power loss. Moreover, there exists a long-felt need in the art for a freezer malfunction notification device that can be easily understood and used by non-technical home or business users.

The subject matter disclosed and claimed herein, in one embodiment thereof, comprises a freezer malfunction notification device. The device is comprised of a body configured to retain a volume of freezable liquid, a lid including an opening and a gasket, an indicator disk, and an optional fastener for mounting to an interior surface of a refrigeration compartment. The body may be constructed from transparent or translucent materials. Upon freezing of the liquid within the body and subsequent placement of the indicator disk on the frozen liquid surface, any subsequent melting of the liquid due to temperature rise causes the disk to descend irreversibly downward within the body. This displacement is retained upon refreezing of the liquid, thereby visually indicating that a defrosting event has occurred.

In this manner, the freezer malfunction notification device of the present invention accomplishes all the foregoing objectives and provides a passive and non-electronic device that persistently records defrosting incidents through physical displacement. The configuration of the liquid-filled body and the free-floating indicator disk enables a clear and permanent signal to users, thereby addressing the problem of unrecognized freezer malfunctions. The device further ensures functionality during power outages or mechanical failures, eliminating reliance on sensors or external power. In addition, the device allows users in both residential and commercial contexts to easily verify the integrity of refrigerated goods. Thus, the freezer malfunction notification device effectively mitigates the risk of food spoilage and ensures greater safety in food storage environments.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a freezer malfunction notification device. The device provides a visual indicator for refrigeration appliances to signal a temperature increase sufficient to cause melting. The passive, non-electronic monitoring of the device enables detection of temporary temperature excursions above the freezing point, potentially compromising stored perishables. The device includes an indicator disk that remains in a changed state within the body even after refrigeration is restored, offering a persistent and irreversible visual alert of prior defrosting. The indicator disk is comprised of thermally stable, non-corrosive materials and may take various shapes. Multiple disks of differing densities or appearances may be employed for multi-level thaw indication.

The body is configured to retain a volume of liquid, which may include various solutions such as water, saline, alcohol-water blends, or aqueous gels. The liquid may be colored for improved contrast with an indicator disk. The body may adopt different geometries and is constructed from transparent or translucent materials to facilitate visibility. A fastener is included to secure the device to refrigeration compartment surfaces. The fastener may be adhesive, magnetic, or mechanical and may be repositionable or removable.

A lid is included with the body and may be of various designs, such as hinged, slideable, or screw-type closures. The lid comprises an opening for inserting the indicator disk while secured, and this opening is fitted with a sealing element that reseals after disk insertion. The lid further comprises a gasket made from compressible material to enhance sealing performance.

In use, the user fills the body with liquid, seals the body with the lid, and places the device in a cold environment to freeze the liquid. After freezing, the disk is inserted to rest on the solid frozen liquid surface. If a temperature rise melts the liquid, the disk descends into the body. Upon refreezing, the disk remains at the lower position within the body, serving as a permanent visual indicator of the defrost and/or re-freezing event.

Accordingly, the freezer malfunction notification device of the present invention is particularly advantageous as it provides a passive and non-electronic device that persistently records defrosting incidents through physical displacement. The configuration of the liquid-filled body and the free-floating indicator disk enables a clear and permanent signal to users, thereby addressing the problem of unrecognized freezer malfunctions. The device further ensures functionality during power outages or mechanical failures, eliminating reliance on sensors or external power. In addition, the device allows users in both residential and commercial contexts to easily verify the integrity of refrigerated goods. Thus, the freezer malfunction notification device effectively mitigates the risk of food spoilage and ensures greater safety in food storage environments.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a freezer malfunction notification device of the present invention with the disk in a first position in accordance with the disclosed architecture;

FIG. 2 illustrates a front view of one potential embodiment of a freezer malfunction notification device of the present invention with the disk in a second position in accordance with the disclosed architecture;

FIG. 3 illustrates a rear perspective view of one potential embodiment of a freezer malfunction notification device of the present invention in accordance with the disclosed architecture; and

FIG. 4 illustrates a flowchart of a method of using one potential embodiment of a freezer malfunction notification device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a freezer malfunction notification device that provides a persistent and irreversible visual indicator of defrosting events. There also exists a long-felt need in the art for a freezer malfunction notification device that operates without electricity or sensors and functions reliably during power loss. Moreover, there exists a long-felt need in the art for a freezer malfunction notification device that can be easily understood and used by non-technical home or business users.

The present invention, in one exemplary embodiment, is comprised of a freezer malfunction notification device. The device functions as a visual indicator for refrigeration appliances by signaling a temperature increase sufficient to cause melting. Through passive, non-electronic monitoring, the device enables recognition of temporary temperature excursions above the freezing point, which may compromise stored perishables. An indicator disk housed within the device remains in a displaced position even after refrigeration conditions are restored, thereby providing a persistent and irreversible alert of a prior defrosting event. The disk is comprised of thermally stable, non-corrosive materials and may be fabricated in various shapes. In some configurations, multiple disks of varying densities or appearances may be utilized to indicate different levels of thawing.

The body is designed to retain a volume of liquid, which may include solutions such as water, saline, alcohol-water blends, or aqueous gels. For enhanced visibility, the liquid may be colored to contrast with the indicator disk. The body may be manufactured in various geometries and is formed from transparent or translucent materials to ensure visual clarity. A fastener is incorporated to attach the device to surfaces within a refrigeration compartment, and may employ adhesive, magnetic, or mechanical mechanisms. In some embodiments, the fastener may be repositionable or detachable.

A lid is integrated with the body and may be implemented in various configurations, including hinged, slideable, or screw-type closures. The lid features an opening that allows for insertion of the indicator disk while remaining attached to the body. This opening is equipped with a sealing element that automatically reseals after the disk is inserted. Additionally, a gasket formed from a compressible material is included in the lid to enhance sealing efficacy.

The operational method involves filling the body with liquid, securing the lid, and placing the device in a freezing environment until the liquid solidifies. After freezing is achieved, the indicator disk is inserted onto the frozen surface. In the event of a temperature increase that causes the frozen liquid to melt, the disk sinks toward the bottom of the body. Once the liquid refreezes, the disk remains in the lowered position, serving as a permanent visual indicator of the defrosting and subsequent refreezing event.

As a result, the device offers a distinct advantage by utilizing a passive, non-electronic mechanism that persistently records defrost incidents through physical displacement. The combination of a liquid-filled body and a free-floating disk provides a clear, enduring indication for users, effectively addressing the issue of undetected freezer malfunctions. The device further continues to operate during power outages or mechanical failures, independent of sensors or power sources. Therefore, the simplicity and reliability of the device allow users in both residential and commercial settings to confirm the status of refrigerated goods, thereby reducing the risk of spoilage and enhancing food safety.

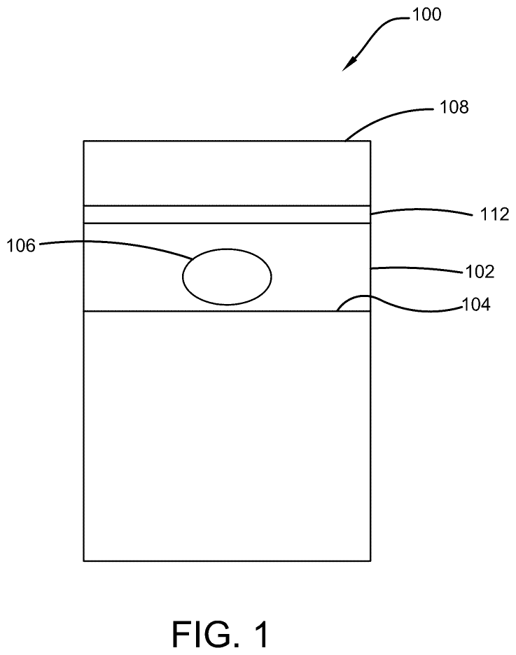

Referring initially to the drawings, FIG. 1 illustrates a front view of one potential embodiment of a freezer malfunction notification device 100 of the present invention with the disk 106 in a first position in accordance with the disclosed architecture. The device 100 provides a visual indicator that a refrigeration appliance such as, but not limited to, a refrigerator, freezer, portable cooler, or cold storage container, has experienced a temperature increase sufficient to cause melting. This passive, non-electronic monitoring capability enables users to detect whether the internal environment of a refrigeration unit has temporarily risen above the freezing point, which may result in the spoilage or compromise of perishable goods. The device 100 is configured to retain the indication status even if the refrigeration conditions are subsequently restored, thereby providing a persistent and irreversible visual alert of a prior defrosting event that might otherwise go unnoticed.

The device 100 is comprised of a body 102 configured to retain a volume of liquid 104, such as, but not limited to, water, saline solution, alcohol-water mixtures, ethylene glycol blends, or aqueous gel compositions. In one embodiment, the liquid 104 may be a colored liquid to improve contrast with an indicator disk 106, as will be explained more fully below. The body 102 may be various geometries including, but not limited to, rectangular prisms, cuboids, cylinders, truncated cones, spheres, domes, or custom-formed enclosures adapted to fit within specific refrigeration compartments. The body 102 may be made from transparent or translucent materials such as, but not limited to, polycarbonate, acrylic, polyethylene terephthalate (PET), polystyrene, polymethyl methacrylate (PMMA), or co-polyester blends.

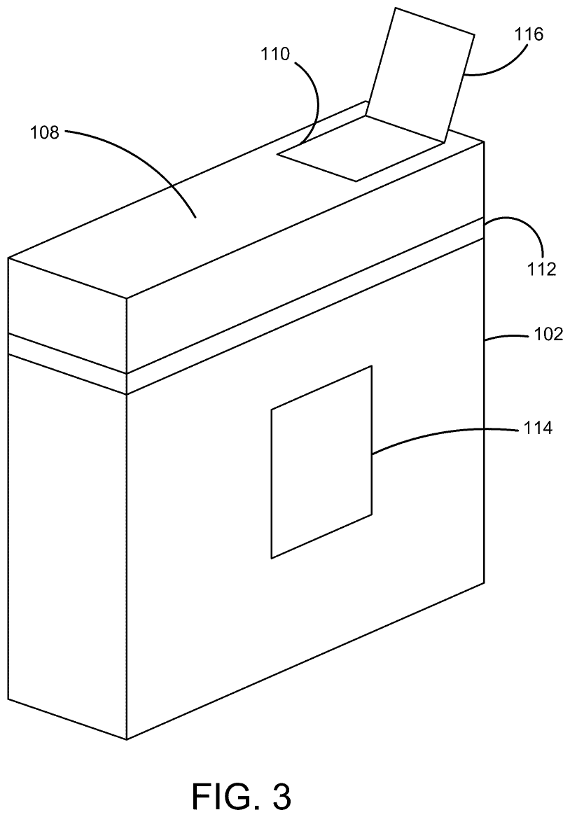

The body 102 may include a lid 108 which may be configured as any lid type such as, but not limited to, a hinged lid with integral living hinge, a slideable track-mounted lid, a snap-on removable lid, a tethered cap, a threaded screw cap, a bayonet-lock cap, a magnetic closure lid, etc. The lid 108 may be made from materials such as, but not limited to, polypropylene, ABS plastic, or flexible silicone to enable repeated access without degradation. The lid 108 may feature an opening 110, such as a slot, aperture, or dispensing port, dimensioned to permit insertion of the indicator disk 106 into the body 102 while the lid 108 remains secured on the body 102. The opening 110 may include a sealing element 116 (as seen in FIG. 3) such as, but not limited to, a resealable barrier, flexible valve, pressure flap, slit membrane, hinged lid, etc., configured to automatically close or reseal the opening 110 after insertion of the disk 106 into the body 102. The lid 108 may further comprise a gasket 112 formed from a compressible sealing material such as, but not limited to, silicone, thermoplastic elastomer (TPE), nitrile rubber, or closed-cell foam, which enhances the vapor barrier or leak resistance between the lid 108 and the body 102.

The indicator disk 106 may be comprised of a non-corrosive, thermally stable, and density-optimized material such as, but not limited to, stainless steel, brass, anodized aluminum, zinc alloy, high-density polyethylene, polycarbonate, nylon, or composite materials. The disk 106 may be formed in various shapes including, but not limited to, circular, elliptical, rectangular, polygonal, etc. In one embodiment, the disk 106 resembles an object, item, symbol, etc. In some embodiments, the device 100 may have multiple indicator disks 106 of different densities, sizes, or colors that may be sequentially positioned to provide progressive, multi-level indicators for partial thawing, full thawing, or prolonged temperature exposure.

The device 100 may include a fastener 114 (as seen in FIG. 3) configured to secure the device 100 to an interior surface of a refrigeration compartment. The fastener 114 may be comprised of mechanisms such as, but not limited to, pressure-sensitive adhesive pads, double-sided foam tapes, suction cups, magnets, hook and loop strips, spring clips, twist-lock mounts, an adhesive mounting post and female receiving area fastener, integrated rail-slide brackets, etc. In some embodiments, the fastener 114 may be adjustable or detachable from the body 102, allowing the device 100 to be repositioned, rotated, or removed for inspection and reuse.

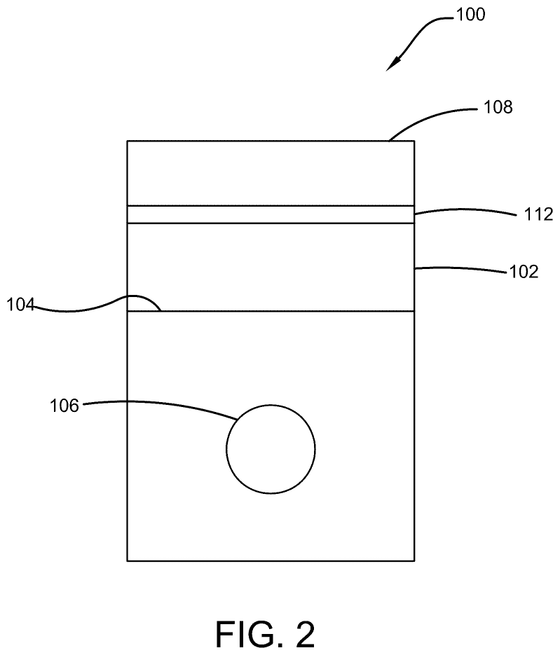

In operation, a user may fill the interior cavity of the body 102 with the selected liquid 104 and seal the body 102 using the lid 108. The sealed device 100 may be placed within a freezer or cold storage compartment where the liquid 104 undergoes a phase change from liquid to solid through freezing. Once the liquid 104 is confirmed to be fully frozen, the user may insert the indicator disk 106 through the opening 110, allowing it to rest atop the surface of the frozen liquid 104, as seen in FIG. 1. During normal refrigeration conditions, the disk 106 remains supported on the solidified liquid 104, suspended at an elevated position within the body 102. If a temperature rise occurs within the refrigeration unit due to power outage, equipment malfunction, door misalignment, or user error, causing the frozen liquid 104 to melt partially or completely, the disk 106 descends under gravitational force through the liquid 104 toward the base of the body 102, as seen in FIG. 2. Upon re-freezing of the liquid 104, the disk 106 remains in the lower position, visibly separated from the original location, thus providing a clear, persistent, and irreversible indication that a defrosting and/or re-freezing event has occurred. This physical displacement informs the user of a past temperature excursion, potentially alerting to the need for inspection or disposal of compromised contents.

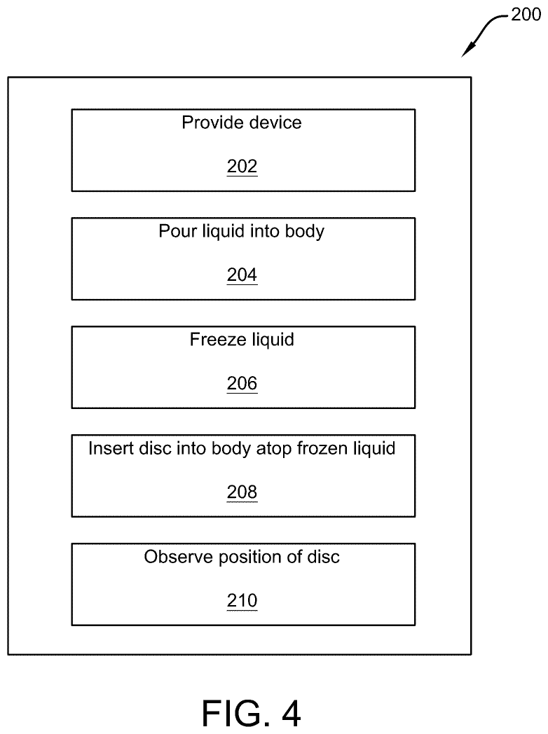

The present invention is also comprised of a method of using 200 the device 100, as seen in FIG. 4. First, a device 100 is provided comprised of a body 102 configured to retain a volume of liquid 104, a lid 108 comprising an opening 110 and a gasket 112, an indicator disk 106, and a fastener 114 (or in any combination described supra) [Step 202]. Then, the liquid 104 is poured into the body 102 to a desired level, and the lid 108 is secured onto the body 102 to seal the contents [Step 204]. Next, the device 100 is placed within a refrigeration environment such as a freezer or cold storage compartment until the liquid 104 is fully frozen [Step 206]. Once the liquid 104 is confirmed frozen, the indicator disk 106 is inserted into the body 102 through the opening 110 in the lid 108 and positioned atop the surface of the frozen liquid 104 [Step 208]. Thereafter, the device 100 remains in the refrigeration environment during normal operation while the disk 106 stays elevated on the frozen liquid 104. If the temperature inside the refrigeration environment rises above freezing and causes the frozen liquid 104 to melt, the disk 106 descends under gravitational force to the bottom of the body 102. Upon refreezing of the liquid 104, the disk 106 remains in the lowered position, visibly separated from its original placement, thereby providing a persistent and irreversible visual indicator of a defrosting event. Then, a user can observe the position of the disk 106 to determine if a refreezing event has occurred [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “freezer malfunction notification device” and “device” are interchangeable and refer to the freezer malfunction notification device 100 of the present invention.

Notwithstanding the foregoing, the freezer malfunction notification device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the freezer malfunction notification device 100 as shown in the FIGS. are for illustrative purposes only, and that many other sizes and shapes of the freezer malfunction notification device 100 are well within the scope of the present disclosure. Although the dimensions of the freezer malfunction notification device 100 are important design parameters for user convenience, the freezer malfunction notification device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A freezer malfunction notification device comprising:
a body comprised of a lid;
a liquid disposed within the body; and
an indicator disk.

2. The freezer malfunction notification device of claim 1, wherein the liquid is comprised of a water, a saline solution, an alcohol-water mixture, an ethylene glycol blend, or an aqueous gel.

3. The freezer malfunction notification device of claim 2, wherein the liquid is comprised of a colored liquid.

4. The freezer malfunction notification device of claim 1, wherein the lid is comprised of a hinged lid with integral living hinge, a slideable track-mounted lid, a snap-on removable lid, a tethered cap, a threaded screw cap, a bayonet-lock cap, or a magnetic closure lid.

5. The freezer malfunction notification device of claim 1 further comprised of a gasket.

6. The freezer malfunction notification device of claim 1, wherein the body is comprised of a transparent body.

7. The freezer malfunction notification device of claim 1, wherein the indicator disk is comprised of a non-corrosive material.

8. The freezer malfunction notification device of claim 1, wherein the indicator disk resembles an object, an item, or a symbol.

9. A freezer malfunction notification device comprising:
a transparent body comprised of a lid, the lid comprised of an opening;
a liquid disposed within the body;
an indicator disk; and
a fastener.

10. The freezer malfunction notification device of claim 9, wherein the opening is comprised of a slot or an aperture.

11. The freezer malfunction notification device of claim 9 further comprised of a gasket.

12. The freezer malfunction notification device of claim 11, wherein the gasket is comprised of a silicone, a thermoplastic elastomer, a nitrile rubber, or a closed-cell foam.

13. The freezer malfunction notification device of claim 9, wherein the fastener is comprised of an adhesive pad, a foam tape, a suction cup, a magnet, a hook and loop strip, a spring clip, a twist-lock mount, or a rail-slide bracket.

14. The freezer malfunction notification device of claim 9, wherein the opening is comprised of a sealing element.

15. The freezer malfunction notification device of claim 9, wherein the sealing element is comprised of a resealable barrier, a flexible valve, a pressure flap, a slit membrane, or a hinged lid.

16. The freezer malfunction notification device of claim 9, wherein the indicator disk is comprised of a non-corrosive material.

17. The freezer malfunction notification device of claim 9, wherein the indicator disk resembles an object, an item, or a symbol.

18. The freezer malfunction notification device of claim 9, wherein the liquid is comprised of a water, a saline solution, an alcohol-water mixture, an ethylene glycol blend, or an aqueous gel.

19. The freezer malfunction notification device of claim 18, wherein the liquid is comprised of a colored liquid.

20. A method of using a freezer malfunction notification device, the method comprising the following steps:
providing a freezer malfunction notification device comprised of a body configured to retain a liquid, a lid comprising an opening, an indicator disk, and a fastener;
filling the body with the liquid and sealing the body with the lid;
placing the freezer malfunction notification device in a refrigeration environment until the liquid is fully frozen;
inserting the indicator disk through the opening and onto the surface of the liquid; and
observing a position of the indicator disk within the body to determine if a defrosting event has occurred.
